(19) United States
(12) Patent Application Publication
(10) Pub. No.: US 2010/0050687 A1
(43) Pub. Date: Mar. 4, 2010

(54) LIQUEFACTION OF GASEOUS CARBON-DIOXIDE REMAINDERS DURING ANTI-SUBLIMATION PROCESS

(75) Inventor: Wolfgang Georg Hees, Malmo (SE)

Correspondence Address: ALSTOM POWER INC.;INTELLECTUAL PROPERTY LAW DEPT., P.O. BOX 500, WINDSOR, CT, 06095, US

(73) Assignee: ALSTOM TECHNOLOGY LTD, Baden (CH)

(21) Appl. No.: 12/509,772

(22) Filed: Jul. 27, 2009

Related U.S. Application Data
(60) Provisional application No. 61/094,084, filed on Sep. 4, 2008.

(51) Int. Cl. C02F 1/22; B01D 9/04; F25J 1/00

(52) U.S. Cl. 62/532; 62/541; 62/606

(57) ABSTRACT

The present invention relates to methods and systems for capture of CO₂ from a gas stream by anti-sublimation, comprising the steps of evacuation of liquefied CO₂ from a frosting vessel 1; evacuation of residual gases containing CO₂ from the frosting vessel 1; and refrigeration of evacuated residual gases to a temperature at which liquid CO₂ is formed.

### CROSS-REFERENCE TO RELATED APPLICATION

This application claims the benefit of U.S. Provisional Patent Application Ser. No. 61/094,184 filed Sep. 4, 2008, which is hereby incorporated by reference in its entirety.

### TECHNICAL FIELD

The proposed invention is directed to an anti-sublimation based carbon dioxide (CO₂) removal system and a method for removing CO₂ from a mixed gas stream, such as a flue gas stream.

### BACKGROUND

Several methods are known for CO₂ capture from gas streams. CO₂ can e.g. be removed from gas streams by anti-sublimation. In anti-sublimation based technologies, a gas stream is refrigerated at a suitable pressure to a temperature such that the gaseous CO₂ passes directly from the vapor state to the solid state. Refrigeration is typically performed in one or more frosting vessels in which CO₂ ice is formed on the cold surfaces of the vessel(s). The formed CO₂ ice is subsequently defrosted to obtain liquid CO₂.

U.S. Pat. No. 7,073,348 pertains to a method and a system for extracting carbon dioxide from fumes by anti-sublimation at atmospheric pressure. The method for extracting CO₂ is performed in an apparatus particularly adapted for the production of mechanical energy and comprises the step of refrigerating said fumes at a pressure more or less equal to atmospheric pressure at a temperature such that the carbon dioxide passes directly from the vapor state to the solid state via an anti-sublimation process. During the anti-sublimation phase, CO₂ frost is formed in an anti-sublimation frosting vessel. The anti-sublimation frosting vessel is thereafter prepared for another cycle of anti-sublimation of CO₂ by firstly melting the solid CO₂, i.e. CO₂ passes from the solid phase to the liquid phase at a pressure of 5.2 bar, and secondly transferring the liquid CO₂ by pumping into a heat-insulated reservoir.

Processes for CO₂ capture are very energy consuming. Thus, there is a constant need of improvements of the CO₂ capture yield in order to lower energy consumption and increase overall process efficiency.

### SUMMARY OF THE INVENTION

An object of the present invention is to improve the liquid CO₂ yield in an anti-sublimation process. More specifically, an object is to increase the liquid-to-gas ratio of carbon dioxide coming from a frosting vessel.

Another object is to lower the energy consumption during storage and transport of carbon dioxide captured in an anti-sublimation process.

The above-mentioned objects as well as further objects, which will become apparent to a skilled person after studying the description below, are achieved, in a first aspect, by a method for capture of CO₂ from a gas stream by anti-sublimation, comprising the steps of:
a) evacuation of liquefied CO₂ from a frosting vessel;
b) evacuation of residual gases containing CO₂ from the frosting vessel; and
c) refrigeration and/or compression of evacuated residual gases to a temperature and/or pressure at which liquid CO₂ is formed.

As has become common in this technical field, the term “anti-sublimation” herein refers to a direct gas/solid phase change that occurs when the temperature of the gas in question is below that of its triple point. The term “sublimation” herein refers, as is conventional, to a direct solid/gas phase change.

In the present context, the term “gas stream” may refer to a stream of any gas mixture comprising CO₂. A “gas stream” may, however, typically be a stream of a flue gas resulting from combustion of organic material such as renewable or non-renewable fuels.

The term “defrosting” herein refers to a transformation of ice to another state. In particular it is referred to the transformation of CO₂ ice, i.e. solid CO₂, to another state.

The term “frosting vessel” as used herein generally refers to one or more frosting vessels for capture of CO₂ from a gas stream by frosting CO₂ ice followed by defrosting CO₂ ice to obtain liquid CO₂. Thus, in one or more frosting vessels, gaseous CO₂ is transformed to solid CO₂ by anti-sublimation. This is followed by defrosting solid CO₂ to obtain CO₂ in liquid or gaseous form.

In an anti-sublimation process, carbon dioxide may be captured and thus removed from a gas stream, such as a flue gas stream, by forming a liquid in one or more frosting vessels. As described above, CO₂ may initially be liquefied in a frosting vessel by anti-sublimation and defrosting. The gas remaining in a frosting vessel after anti-sublimation and defrosting is a mixture of remaining CO₂ and other gaseous components. The present method is directed to the part of the anti-sublimation process following anti-sublimation and defrosting of CO₂ in one or more frosting vessels, namely the evacuation of one or more frosting vessels and the subsequent treatment of the liquid and gaseous phases evacuated from the frosting vessel.

In the method according to the first aspect, the liquefied part of the CO₂ is evacuated from the frosting vessel. The gas mixture containing gaseous CO₂ and remaining in the frosting vessel after anti-sublimation and defrosting, i.e. residual gases, is evacuated from the frosting vessel and refrigerated to a temperature such as to provide liquid CO₂ . Gaseous CO₂ contained in the residual gases hence forms a liquid. In this way, the overall CO₂ liquid-to-gas ratio of the anti-sublimation process may be improved. In other words, the yield of captured CO₂ in liquid form may be improved. Liquid CO₂ not only takes up less volume than gaseous CO₂, liquid CO₂ also requires less energy than gaseous CO₂ for compression. Transport and storage of CO₂ requires substantial compression and thus, the present method may lead to lower energy consumption during subsequent storage and transport.

Evacuated residual gases are refrigerated to a temperature and/or compressed to a pressure at which CO₂ contained in the residual gases is transferred to the liquid state. In principle, at a temperature and a pressure lower than the triple point temperature and pressure, CO₂ goes directly from the gas phase to the solid phase. When refrigerating gaseous CO₂ at pressures higher than the triple point pressure, CO₂ goes from the gas phase to the liquid phase. The triple point of CO₂ is at approximately 520 kPa and approximately −56.6° C. In the present context, “refrigeration” and “compression” should be understood as adapting temperature and/or pressure conditions for a phase transition from gas to liquid to occur. Depending on the initial temperature and (partial) pressure of a particular gaseous component, such as CO₂ contained in the residual gases, phase transition might take place by adjusting only pressure, not temperature. Thus, liquid CO₂ may in principle be formed from gaseous CO₂ without altering the temperature. In one embodiment of the present method, refrigeration of residual gases is preferably performed at a CO₂ pressure above the triple point pressure, i.e. at a pressure of at least 520 kPa, such as at pressures of 520-1040 kPa, or at pressures of 520-780 kPa. In specific embodiments, refrigeration may be performed at a CO₂ pressure of at least 600 kPa or at least 650 kPa.

Similarly, the pressure of evacuated liquefied CO₂ may be held above the triple point at a temperature such as to remain liquid.

Depending on the pressure conditions in the frosting vessel during evacuation and the desired pressure conditions when refrigerating the residual gases, it may be required that the residual gas pressure, and in particular the CO₂ pressure, is controlled. Accordingly, the pressure of the evacuated residual gases may be controlled by a pressure control system. Such a pressure control system could be any suitable system for monitoring and adjusting the pressure of a gas. The pressure control system may for example comprise at least one pump. As used herein, a “pump” includes any kind of fluid pumping equipment. In this case, any suitable pumping equipment for pumping gas may be used, such as gas pumps, pneumatic pumps, blowers or compressors. Instead of, or in addition to, one or more pumps, the pressure control system may comprise a valve system. A valve system should be understood as any control- and regulation device for fluids such as liquids and gases. The valve system may in turn comprise at least one pressure controlling valve.

In another embodiment of the present method, evacuated residual gases are refrigerated above the triple point pressure, for example at a temperature of at least −56.6° C., such as at least −55° C., at least −50° C. or at least −45° C. It is understood that suitable refrigeration temperatures for residual gases depend on the CO₂ pressure, and evidently on the phase diagram of CO₂. Refrigeration may be accomplished by passing evacuated residual gases through a heat exchanger, e.g. by passing residual gases in a pipe in contact with a cold medium from another part of the anti-sublimation process. Alternatively, refrigeration of evacuated residual gases may be performed by passing evacuated residual gases through a heat exchanger submersed in the liquefied CO₂ evacuated in step a). Thus, the low temperature of the liquid CO₂ is utilized in order to transform residual CO₂ into liquid form.

Liquid contents of a frosting vessel, i.e. liquefied CO₂, may be evacuated separately from gaseous contents, i.e. the gas mixture of residual gases. Liquid CO₂ may preferably be evacuated prior to residual gases, thus, step a) of the present method may be performed before step b). Thus, a frosting vessel may be emptied of its entire liquid content prior to proceeding with emptying its gaseous content.

In one embodiment of the present method, liquid CO₂ formed by refrigeration of evacuated residual gases may be separated from the remaining residual gases. The separated liquid CO₂ may subsequently be combined with the liquefied CO₂ evacuated from the frosting vessel in step a). Combination of the liquid portions of CO₂ may decrease the costs for CO₂ storage and transportation.

The objects of the present invention are also achieved in another aspect, by an anti-sublimation system for capturing CO₂ from a gas stream, said system comprising

a frosting vessel for liquefying CO₂ contained in the gas stream;

a liquid CO₂ storage tank in fluid connection with the frosting vessel, wherein the storage tank is configured to receive liquid CO₂ from the frosting vessel; and

a heat exchanger in fluid connection with the frosting vessel, wherein the heat exchanger is configured to receive residual gases containing CO₂ from the frosting vessel and to refrigerate the residual gases to a temperature at which liquid CO₂ is formed.

In this aspect of an anti-sublimation system, a frosting vessel should be understood as one or more frosting vessels for anti-sublimation of CO₂ contained in a gas stream followed by defrosting of CO₂ ice to obtain CO₂ in gaseous/liquid form.

By an anti-sublimation system comprising a frosting vessel, a storage tank and a heat exchanger adapted to refrigerate residual gases containing CO₂ to a temperature at which liquid CO₂ is formed, the CO₂ liquid-to-gas ratio may be improved and thus the liquid CO₂ capture yield of the overall anti-sublimation process.

The CO₂ pressure within the heat exchanger, i.e. the partial pressure of gaseous CO₂, may be at least 520 kPa, such as 520-1040 kPa, such as 520-780 kPa. In specific embodiments, the CO₂ pressure within the heat exchanger may be at least 600 kPa or at least 650 kPa. In order to maintain the pressure at a suitable level, it may be required to control the gas pressure within the heat exchanger. Consequently, in one embodiment the anti-sublimation system further comprises a pressure control system for controlling the pressure, in particular the CO₂ pressure, within the heat exchanger. As understood by the skilled person, any suitable pressure control system may be used. Preferably, the pressure control system may comprise at least one pump and/or optionally a valve system. A valve system may comprise one valve for controlling the liquid flow from the frosting vessel and/or optionally one valve for controlling the gas flow from the frosting vessel.

In one embodiment of the present anti-sublimation system, at pressures above the triple point, the temperature of the residual gases may be adjusted for liquid CO₂ to be formed. For example, the residual gases may be refrigerated to a temperature of at least −56.6° C., such as at least −55° C., at least −50° C. or at least −45° C. In particular, temperature and pressure of residual gases containing CO₂ which are passed through a heat exchanger may for example be controlled in such a way as to provide liquid CO₂.

Liquid CO₂ formed in the heat exchanger, which may be submersed in the liquid CO₂ storage tank, may further be separated from the remaining residual gases in a separator vessel. Thus, in one embodiment, the present anti-sublimation system further comprises a separator vessel configured to receive liquid CO₂ and residual gases coming from the heat exchanger and to separate liquid CO₂ from residual gases. Such a phase separator vessel may further direct separated liquid CO₂ to the CO₂ liquid storage tank, i.e. the storage tank may be configured to receive liquid CO₂ from the separator vessel.

### BRIEF DESCRIPTION OF THE DRAWING

FIG. 1 is a schematic view of an anti-sublimation system for capturing CO₂ from a gas stream.

### DETAILED DESCRIPTION

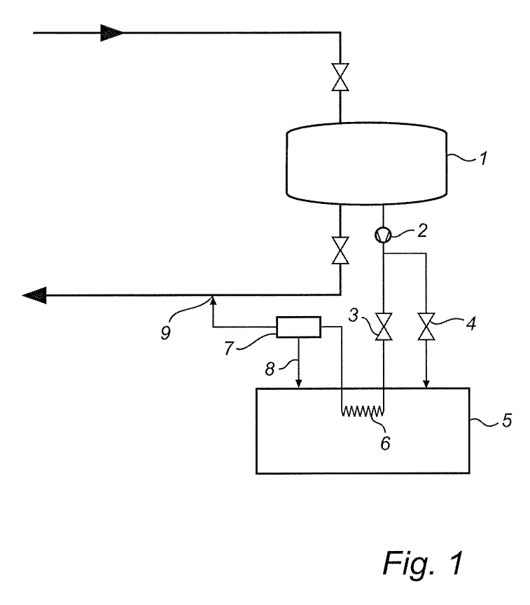

An embodiment of an anti-sublimation system according to the invention will now be described with reference to FIG. 1. An anti-sublimation system for capturing CO₂ from a gas stream comprises a frosting vessel 1 for liquefying CO₂. Frosting vessel 1, which may be a single vessel or a series of vessels, is configured to receive a gas stream containing CO₂, such as a flue gas stream. CO₂ contained in the gas stream may typically be frosted to form CO₂ ice on cold surfaces in the frosting vessel. Frosting may be performed at atmospheric pressure at e.g. −120° C. By altering the pressure and/or temperature in the same or another frosting vessel, the output may be gaseous or liquid CO₂. Liquid CO₂ may preferably be formed.

After formation of liquid CO₂, the frosting vessel 1 may be evacuated by pumping. A pump 2 evacuates liquid CO₂ via valve 4 to a liquid CO₂ storage tank 5. Valve 4 is positioned accordingly to direct liquid CO₂ into storage tank 5. The pressure and the temperature within the storage tank 5 are typically such as to keep the CO₂ in liquid form. The pressure is preferably above the triple point.

After pumping liquefied CO₂ from the frosting vessel 1, the gas remaining in the frosting vessel 1 is a mixture of CO₂ and other gases, e.g. flue gases. Remaining CO₂ gas may be separated without major contamination by other gaseous components. This may be achieved by pumping residual gases (CO₂ and other gaseous components) from the frosting vessel 1 via pump 2 and valve 3 to a heat exchanger 6 submersed in the liquid CO₂ storage tank 5. It is understood that the same pump 2 may be used for pumping residual gases and for pumping liquid CO₂. If only one pump is used, this pump may be a compressor. Alternatively, different pumps may be used for pumping liquid and gas. Valve 3 is positioned accordingly to direct residual gases only to the heat exchanger 6.

Pump 2 thus may have three modes of operation. The pump may initially be inactive until evacuation of the frosting vessel starts. It may then alternately pump liquid and gas coming from the frosting vessel 1. It may preferably be activated by pumping liquid CO₂, followed by pumping residual gases.

The pressure inside the heat exchanger 6 may preferably be maintained at a level which will allow CO₂ to liquefy and the other gaseous components, such as flue gas components, to remain in gas phase. Depending on the composition of the gas stream and the residual gases, the pressure may be adapted to obtain as much CO₂ as possible in liquid form while keeping remaining components in gaseous form. When evacuating residual gases from frosting vessel 1, the gas pressure may be increased by e.g. 50-100%, such as 50-75% above the initial pressure of the residual gases. This pressure increase may allow for greater phase transition of gaseous CO₂ to liquid form. The gas pressure may be adjusted to balance CO₂ liquid formation and energy consumption. This pressure increase may be accomplished by pump 2 and/or by valve 3. To allow for CO₂ phase transition, the partial pressure of CO₂ contained in the residual gases may suitably be at least 520 kPa, such as at least 600 kPa or at least 650 kPa.

The gas pressure level may furthermore be controlled via, for example, a pressure control system (not shown). In one embodiment, this pressure control system may be software based and include one or more sensors to monitor and report relevant information to a pressure controller (not shown). Additionally, the pressure control system may control the pressure of liquid CO₂ evacuated from frosting vessel 1. In one embodiment, the pressure control system comprises pump 2 and optionally valves 3 and 4, and thus controls the pressure of the contents held therein.

In addition, the pressure control system may be adapted to control the pressure of liquefied CO₂ coming from the frosting vessel and to keep the liquefied CO₂ liquid in the liquid storage tank 5.

Heat exchanger 6 is configured to refrigerate residual gases at a specific pressure to a temperature at which liquid CO₂ is formed. As understood by the skilled person, refrigeration may be accomplished by submersion in the liquid CO₂ storage tank 5, but might equally well be accomplished by any known heat exchanging or refrigeration method. For example, refrigeration of residual gases may be accomplished by a coil, a pipe or pipe fin submersed in liquid CO₂ storage tank 5 or by a coil, a pipe or pipe fin in contact with any cold medium such as a fluid used in the anti-sublimation process.

After refrigeration of residual gases, the mixture of the thus liquefied CO₂ and remaining gaseous components may be passed to the liquid CO₂ storage tank 5. Alternatively, the mixture is passed via separator vessel 7 which is configured to receive liquid CO₂ and residual gases coming from the heat exchanger and to separate liquid CO₂ from residual gases. After phase separation, liquid CO₂ may be directed into the liquid CO₂ storage tank 5 via pipe 8, and remaining residual gases may be directed to the returning gas stream via pipe 9. Alternatively, remaining residual gases may be discharged into the atmosphere.

By liquefying CO₂ contained in residual gases evacuated from frosting vessel 1, the liquid-to-gas ratio in the liquid CO₂ storage tank 5 may be improved, which may lead to lower energy consumption during subsequent transport and storage as well as to a higher CO₂ capture rate of the anti-sublimation based carbon dioxide removal system and method.

The valves 3 and 4 may preferably be controlled automatically via a suitable control system (not shown), so as to open and close the valves at appropriate/predetermined times and for appropriate/predetermined durations in order to allow liquid CO₂ and residual gases to flow into the liquid CO₂ storage tank 5 and the heat exchanger 6 respectively. In one embodiment, the control system (not shown) is a software based control system configured to control the valves 3 and 4. It may also include one or more sensors to monitor and report the status of valves 3 and 4, as well as one or more sensors to monitor and report the filling level of CO₂ in the frosting vessel 1 and the liquid CO₂ storage tank 5.

1. Method for capture of CO₂ from a gas stream by anti-sublimation, comprising the steps of:
a) evacuation of liquefied CO₂ from a frosting vessel;
b) evacuation of residual gases containing CO₂ from the frosting vessel; and
c) refrigeration and/or compression of evacuated residual gases to a temperature and/or pressure at which liquid CO₂ is formed.

2. Method according to claim 1, wherein in step c) refrigeration is performed at a CO₂ pressure of at least 520 kPa, such as at least 600 kPa or at least 650 kPa.

3. Method according to claim 1, wherein the pressure of the evacuated residual gases is controlled by a pressure control system.

4. Method according to claim 3, wherein the pressure control system comprises at least one pump.

5. Method according to claim 4, wherein the pressure control system further comprises a valve system.

6. Method according to claim 2, wherein in step c) evacuated residual gases are refrigerated to a temperature of at least −56.6° C. such as at least −55° C., at least −50° C. or at least −45° C.

7. Method according to claim 1, wherein in step c) refrigeration is performed by passing evacuated residual gases through a heat exchanger submersed in the liquefied CO₂ evacuated in step a).

8. Method according to claim 1, wherein step a) is performed separately from step b).

9. Method according to claim 8, wherein step a) is performed before step b).

10. Method according to claim 1, further comprising the step of d) separating liquid CO₂ formed by refrigeration in step c) from the residual gases.

11. Method according to claim 9, wherein the liquid CO₂ separated in step d) is combined with the liquefied CO₂ evacuated in step a).

12. An anti-sublimation system for capturing CO₂ from a gas stream, said system comprising
i) a frosting vessel for liquefying CO₂ contained in the gas stream;
ii) a liquid CO₂ storage tank in fluid connection with the frosting vessel, wherein the storage tank is configured to receive liquid CO₂ from the frosting vessel; and
iii) a heat exchanger in fluid connection with the frosting vessel, wherein the heat exchanger is configured to receive residual gases containing CO₂ from the frosting vessel and to refrigerate the residual gases to a temperature at which liquid CO₂ is formed.

13. An anti-sublimation system according to claim 12, further comprising iv) a pressure control system for controlling the pressure within the heat exchanger.

14. An anti-sublimation system according to claim 13, wherein the CO₂ pressure within the heat exchanger is at least 520 kPa, such as at least 600 kPa or at least 650 kPa.

15. An anti-sublimation system according to claim 13, wherein the pressure control system comprises at least one pump.

16. An anti-sublimation system according to claim 15, wherein the pressure control system further comprises a valve system.

17. An anti-sublimation system according to claim 13, wherein residual gases are refrigerated to a temperature of at least −56.6° C., such as at least −55° C., at least −50° C. or at least −45° C.

18. An anti-sublimation system according to claim 12, wherein the heat exchanger is submersed in the liquid CO₂ storage tank.

19. An anti-sublimation system according to claim 12, further comprising v) a separator vessel configured to receive liquid CO₂ and residual gases coming from the heat exchanger and to separate liquid CO₂ from residual gases.

20. An anti-sublimation system according to claim 19, wherein the storage tank is configure to receive liquid CO₂ from the separator vessel.
